(19) United States
(12) Patent Application Publication
(10) Pub. No.: US 2025/0223481 A1
(43) Pub. Date: Jul. 10, 2025

(54) NON-FLAMMABLE, COOLING COMPOSITION

(71) Applicants: TOTALENERGIES ONETECH, Courbevoie (FR); CENTRE NATIONAL DE LA RECHERCHE SCIENTIFIQUE, Paris (FR)

(72) Inventors: Nicolas CHAMPAGNE, Solaize (FR); Francis RONDELEZ, Fontenay-Aux-Roses (FR); Marie-Pierre KRAFFT, Strasbourg (FR)

(73) Assignees: TOTALENERGIES ONETECH, Courbevoie (FR); CENTRE NATIONAL DE LA RECHERCHE SCIENTIFIQUE, Paris (FR)

(21) Appl. No.: 18/838,475

(22) PCT Filed: Feb. 15, 2023
(86) PCT No.: PCT/EP2023/053705

§ 371 Date: Aug. 14, 2024

(30) Foreign Application Priority Data
Feb. 16, 2022 (FR) FR2201372

(51) Int. Cl. C09K 5/04

(52) U.S. Cl. CPC C09K 5/044; C09K 2205/128

(57) ABSTRACT

The present invention concerns the use of a composition including at least one hydrocarbon fluid having an initial boiling point of at least 30° C., or at least one base oil; perfluorooctyl bromide, for cooling in a mobile or stationary system and/or for preventing or delaying the spread of thermal runaway in a mobile or stationary system.

### CROSS-REFERENCE TO RELATED APPLICATIONS

This application is a U.S. national phase entry of PCT Patent Application Serial No. PCT/EP2023/053705, filed on Feb. 15, 2023, which claims priority to the French Patent Application Serial No. FR2201372, filed on Feb. 16, 2022, both of which are incorporated by reference herein.

### TECHNICAL FIELD

The present invention relates to the field of non-flammable cooling compositions for static or mobile applications, in particular for electric or hybrid vehicles and more particularly for the cooling of batteries and power electronics but also for delaying and/or preventing the spread of fire.

### BACKGROUND

Evolving international standards for the reduction of CO2 emissions, but also for the reduction of energy consumption, are prompting vehicle manufacturers to put forward alternative solutions to internal combustion engines. One solution identified by vehicle manufacturers is to replace internal combustion engines by electric motors. Research into the reducing of CO2 emissions has therefore led to the development of electric vehicles by a certain number of automobile companies.

By “electric vehicle” in the meaning of the present invention, it is meant a vehicle comprising an electric motor as sole propulsion means, contrary to a hybrid vehicle which comprises an internal combustion engine and an electric motor as combined propulsion means. By “propulsion system” in the meaning of the present invention, it is meant a system comprising the mechanical parts required to propel an electric vehicle. The propulsion system therefore more particularly encompasses an electric motor comprising the rotor-stator assembly, power electronics (dedicated to regulating speed), transmission (also called reducer) and a battery.

In general, it is necessary, in electric or hybrid vehicles, to use compositions meeting the need to lubricate and/or to cool the different parts of the propulsion system recalled above. According to type of system, only one same composition is able to carry out the functions of lubrication and cooling, whilst in other systems there can be provided both a lubricating composition dedicated to this function for the parts of the propulsion system, as just described, and a different cooling composition in particular for the batteries and power electronics. This second alternative is particularly applied when hydrocarbon fluids are used having a boiling point higher than or equal to 30° C., and in particular between 30° C. and 350° C., more particularly between 30° C. and 250° C., for the cooling of batteries and power electronics as detailed below. Said hydrocarbon fluids do not have lubricating properties.

Lubricating compositions, also called “lubricants”, are routinely used in propulsion systems such as electric motors, for the main purpose of reducing friction forces between the different moving metal parts in a motor. They are also efficient in preventing early wear and even damage to these parts and in particular to the surface thereof. To achieve this, a lubricating composition is conventionally composed of one or more base oils with which several additives are generally associated dedicated to stimulating the lubricating performance of the base oils e.g. friction modifying additives. Additionally, electric propulsion systems generate heat when in operation via the electric motor, the power electronics, and batteries. Since the amount of heat generated is greater than the amount of heat normally dissipated into the environment, provision must be made for cooling of the motor, power electronics and batteries. In general, cooling takes place on several parts of the heat-generating propulsion system and/or on the heat-sensitive parts of said system, to prevent the reaching of hazardous temperatures with respect to the power electronics and batteries in particular.

Conventionally, it is known to cool electric motors with air or water, optionally associated with glycol. Such cooling is not optimal and is even insufficient with new advances in the propulsion system of electric or hybrid vehicles.

Flame retardants are also known that can be used in fluids including oily fluids, and in particular for industrial applications of industrial cleaning type. However, some oils that are virtually non-flammable are generally composed of heavy halogen compounds such as polychlorotrifluoroethylenes (PCTFEs). Also, some organic, perfluorinated fluids of ether or ketone type are also known as cooling fluids for the propulsion system of electric vehicles. Despite the cooling systems applied to lubricate the propulsion systems of electric or hybrid vehicles, the risk cannot be fully set aside that the battery may overheat at a cell, which could lead to an explosion and overall igniting of the battery known as “thermal runaway”.

It is therefore the objective of the present invention to provide a composition that is both cooling and non-flammable, allowing the cooling and flame-proofing of mobile or stationary systems.

### SUMMARY

More specifically, the present invention concerns the use of a composition comprising:
at least one hydrocarbon fluid having an initial boiling point of at least 30° C., or at least one base oil.
perfluorooctyl bromide for cooling in a mobile or stationary system and/or to prevent or delay the spread of thermal runaway within a mobile or stationary system.

In one embodiment, the composition comprises:
from 15 to 99% by weight of hydrocarbon fluid(s) having an initial boiling point of at least 30° C., and/or of base oil(s),
from 1 to 85% by weight of perfluorooctyl bromide,
relative to the total weight of the composition.

In one embodiment, the composition additionally comprises at least one flame retardant replying to formula (I):

RF-L-RH (I)
where:
RF is a hydrocarbon group, in particular having from 1 to 22, preferably 1 to 20, more preferably 1 to 16 carbon atoms,
RH is a hydrocarbon group in particular having from 1 to 22, preferably 1 to 20, more preferably 1 to 16 carbon atoms, and
L is a linker chosen from the following groups: —CH₂—, —CH═CH—, —O—, —S— or —PO₄—,
RF and/or RH possibly also comprising at least one element chosen from among elements of the halogen class such as preferably fluorine, bromine, and/or chlorine.

In one embodiment, the composition comprises:
from 15 to 94% by weight of hydrocarbon fluid(s) having an initial boiling point of at least 30° C., and/or of base oil(s),
from 1 to 75% by weight of perfluorooctyl bromide,
from 5 to 35% by weight of flame retardant(s) meeting formula (I), relative to the total weight of the composition.

In one embodiment, the composition is in direct contact with at least one unit of the mobile or stationary system. In one embodiment, the composition is used as battery cooling composition, as data centre cooling system, as hydraulic fluid, as cooling fluid for antenna of 5G type, as heat exchange fluid in a heating system, as heat exchange fluid for charging stations including for electric vehicles, as heat exchange fluid for energy storage systems, or as heat exchange fluid for photovoltaic panels, as working fluid for heat pumps. In one embodiment, the mobile system is a propulsion system of an electric or hybrid vehicle, preferably a battery and/or the power electronics of an electric or hybrid vehicle. In one embodiment, the stationary system is chosen from among data centres, heating systems, heat pumps, relay antennas of 5G type, hydraulic systems, charging stations including for electric vehicles, energy storage systems, or photovoltaic panels.

A further subject of the invention is a composition comprising, relative to the total weight of the composition:
from 15 to 94% by weight of hydrocarbon fluid(s) having an initial boiling point of at least 30° C., and/or of base oil(s),
from 1 to 75% by weight of perfluorooctyl bromide,
from 5 to 35% by weight of flame retardant(s) meeting formula (I):

RF-L-RH (I)
where:
RF is a hydrocarbon group,
RH is a hydrocarbon group, and
L is a linker chosen from the following groups: —CH₂—, —CH═CH—, —O—, —S— or —PO4-,
RF and/or RH possibly also comprising an element chosen from among elements of the halogen class,
a composition in which the weight ratio of perfluorooctyl bromide to hydrocarbon fluid(s) and/or base oil(s) is lower than 1.

In one embodiment of the composition of the invention, the weight ratio of perfluorooctyl bromide to hydrocarbon fluid(s) and/or base oil(s) is lower than 0.75, preferably lower than 0.5. The composition defined in the invention has combined properties of coolant and flame retardant. The composition defined in the invention additionally has properties of resistance to fire also known as non-flammability, accounting for the usefulness thereof with respect to batteries.

The present invention more particularly proposes the use of the composition defined herein at least for cooling purposes, but also to delay and/or prevent the spread of fire within the elements of a propulsion system and additionally to ensure the safety of batteries in particular Lithium-ion (Li-ion) or Nickel-Cadmium (Ni—Cd) batteries, by imparting flame resistance thereto. The composition defined in the present invention additionally has improved stability. It is typically in the form of a nano-emulsion that is thermodynamically more stable than a conventional emulsion.

In the remainder hereof, the expressions “of between . . . and . . . ”, “ranging from . . . to . . . ” and “varying from . . . to . . . ” are equivalent and are intended to indicate that the limits are included, unless otherwise stated. Unless otherwise stated. the quantities in a product are expressed by weight relative to the total weight of the product.

### DETAILED DESCRIPTION

The present invention concerns the use of a composition comprising:
at least one base oil or at least one hydrocarbon fluid having an initial boiling point of at least 30° C.;
perfluorooctyl bromide for cooling in a mobile or stationary system and/or to prevent or delay the spread of thermal runaway within a mobile or stationary system.

### Hydrocarbon Fluid

In the meaning of the present invention, by “hydrocarbon fluid”, it is meant any fluid comprising molecules of saturated or unsaturated, linear hydrocarbons, possibly also comprising aromatic or cyclic groups, or heteroatoms. In the present invention, “paraffins” designate hydrocarbons having straight or linear chains (also called “normal paraffins”) and having branched chains (also called isoparaffins). As heteroatoms, in the present invention, particular mention can be made of nitrogen and oxygen.

The hydrocarbon fluid used in the invention has an initial boiling point of at least 30° C., preferably at least 50° C. In addition to conventional “liquid” fluids, fluids of “gas” type can be used in the composition of the invention, which can subsequently be used as working fluid in systems of heat pump type. In one particular embodiment of the invention, the hydrocarbon fluid has a boiling point of between 50° C. and 350° C., in particular between 60° C. and 300° C., and more particularly between 80° C. and 250° C. Preferably, the hydrocarbon fluid used in the invention has a bio-based carbon content higher than or equal to 90% by weight, relative to the total weight of the hydrocarbon fluid.

In one particular embodiment of the invention, the hydrocarbon fluid comprises alkanes, or linear molecules of saturated hydrocarbons having a non-cyclic chain, in particular having between 12 and 30 carbon atoms, in an amount of between 80 and 100% by weight relative to the total weight of the hydrocarbon fluid, even between 90 and 100% by weight, and for example between 95 and 100% by weight. In one particular embodiment of the invention, the hydrocarbon fluid used in the invention comprises more than 50% by weight of isoparaffins, preferably more than 75% by weight of isoparaffins. Preferably, the components of the hydrocarbon fluid are chosen from among isoparaffins having 10 to 30 carbon atoms, preferably 11 to 24 carbon atoms, and more preferably 12 to 18 carbon atoms.

A cooling composition of the invention advantageously has a weight content of isohexadecane lower than or equal to 50%. In one particular embodiment of the invention, the hydrocarbon fluid comprises from 85 to 100% by weight of isoparaffins, and a content of normal paraffins ranging from 0 to 15% by weight. The hydrocarbon fluid advantageously has a normal paraffin content lower than or equal to 10% by weight, more preferably lower than or equal to 5% by weight, further preferably lower than or equal to 2% by weight, relative to the total weight of the hydrocarbon fluid.

The isoparaffins are advantageously non-cyclic isoparaffins. Preferably, the hydrocarbon fluid has a weight ratio of isoparaffins to normal paraffins of at least 12:1, preferably at least 15:1 and more preferably of at least 20:1. In one more particular embodiment, the hydrocarbon fluid does not comprise any normal paraffins.

In one embodiment, the hydrocarbon fluid preferably has a weight content of isoparaffins ranging from 90 to 100% and a content of normal paraffins ranging from 0 to 10%, preferably 95 to 100% of isoparaffins chosen from among alkanes having 12 to 30 carbon atoms, preferably 12 to 24 carbon atoms, more preferably 12 to 22 carbon atoms.

In one particular embodiment, the hydrocarbon fluid conforming to the invention comprises a majority of molecules i.e. more than 90% by weight having 12 to 18 carbon atoms, such as isoparaffins. In another embodiment, the hydrocarbon fluid conforming to the invention comprises from 60 to 95% by weight, preferably 80 to 98% by weight of isoparaffins chosen from the group composed of C15 isoparaffins, C16 isoparaffins, C17 isoparaffins, C18 isoparaffins, and mixtures of two or more thereof.

In one embodiment, the hydrocarbon fluid comprises:
isoparaffins having 15 carbon atoms and isoparaffins having 16 carbon atoms in a total amount ranging from 80 to 98% by weight, relative to the total weight of the hydrocarbon fluid; or
isoparaffins having 16 carbon atoms, isoparaffins having 17 carbon atoms and isoparaffins having 18 carbon atoms in a total amount ranging from 80 to 98% by weight, relative to the total weight of the hydrocarbon fluid; or
isoparaffins having 17 carbon atoms, and isoparaffins having 18 carbon atoms in a total amount ranging from 80 to 98% by weight, relative to the total weight of the hydrocarbon fluid.

In one preferred embodiment of the invention, the hydrocarbon fluid comprises isoparaffins having 17 carbon atoms and isoparaffins having 18 carbon atoms in a total amount ranging from 80 to 98% by weight, relative to the total weight of the hydrocarbon fluid.

Examples of preferred hydrocarbon fluids of the invention are those comprising:
from 30 to 70% by weight of C15 isoparaffins and from 30 to 70% by weight of C16 isoparaffins, preferably 40 to 60% by weight of C15 isoparaffins and 35 to 55% by weight of C16 isoparaffins, relative to the total weight of the hydrocarbon fluid;
from 5 to 25% of C15 isoparaffins, from 30 to 70% of C16 isoparaffins and from 10 to 40% of C17 isoparaffins, preferably 8 to 15% of C15 isoparaffins, 40 to 60% of C16 isoparaffins and 15 to 25% of C17 isoparaffins, relative to the total weight of the hydrocarbon fluid;
from 5 to 30% of C17 isoparaffins and from 70 to 95% of C18 isoparaffins, preferably 10 to 25% of C17 isoparaffins and 70 to 90% of C18 isoparaffins, relative to the total weight of the hydrocarbon fluid.

The hydrocarbon fluid preferably has a weight content of naphthenic compounds lower than or equal to 3%, preferably lower than or equal to 1%, more preferably lower than or equal to 0.5%, and further preferably lower than or equal to 500 ppm, even 100 ppm or 50 ppm. In another preferred embodiment, the hydrocarbon fluid has a weight content of isoparaffins ranging from 90 to 100%, a weight content of normal paraffins ranging from 0 to 10%, and a weight content of naphthenic compounds lower than or equal to 1%. Preferably, the hydrocarbon fluid has a weight content ranging from 95 to 100% of isoparaffins, 0 to 5% of normal paraffins and a weight content of naphthenic compounds lower than or equal to 0.5%. More preferably it has a weight content of 98% to 100% of isoparaffins, 0 to 2% of normal paraffins and a weight content of naphthenic compounds lower than or equal to 100 ppm.

The hydrocarbon fluid is advantageously free of aromatic compounds. For example, it is meant a weight content of aromatic compounds lower than or equal to 500 ppm, preferably lower than or equal to 300 ppm, more preferably lower than or equal to 100 ppm, further preferably lower than or equal to 50 ppm, and advantageously lower than or equal to 20 ppm, measured for example by UV spectrometry.

The weight content of isoparaffins, of normal paraffins, of naphthenic and/or aromatic compounds in the hydrocarbon fluid can be determined following methods well known to those skilled in the art. As nonlimiting example, mention can be made of a gas chromatography method.

In another preferred embodiment, the hydrocarbon fluid has a weight content of isoparaffins ranging from 90 to 100%, a weight content of normal paraffins ranging from 0 to 10%, a weight content of naphthenic compounds lower than or equal to 1%, and a weight content of aromatic compounds lower than or equal to 500 ppm. Preferably, the hydrocarbon fluid has a weight content ranging from 95 to 100% of isoparaffins, from 0 to 5% of normal paraffins, a weight content of naphthenic compounds lower than or equal to 0.5% and a weight content of aromatic compounds lower than or equal to 300 ppm, preferably lower than 100 ppm, more preferably lower than 50 ppm and advantageously lower than 20 ppm. Also preferably, the hydrocarbon fluid has a weight content ranging from 95 to 100% of isoparaffins, from 0 to 5% of normal paraffins and a weight content of aromatic compounds lower than or equal to 100 ppm. More preferably, it has a weight content ranging from 98 to 100% of isoparaffins, from 0 to 2% of normal paraffins, a weight content of naphthenic compounds lower than or equal to 100 ppm and a weight content of aromatic compounds lower than or equal to 100 ppm.

The hydrocarbon fluid also preferably has an extremely low weight content of sulfur compounds, typically lower than or equal to 5 ppm, preferably lower than or equal to 3 ppm, and more preferably lower than or equal to 0.5 ppm—a level that is too low for detection by conventional analysers of low sulfur content. The hydrocarbon fluid also preferably has a flash point higher than or equal to 110° C., preferably higher than or equal to 120° C. and more preferably higher than or equal to 140° C. according to standard EN ISO 2719. A high flash point, typically higher than 110° C., inter alia allows the remedying of problems related to safety during storage and transport by lowering the flammability of hydrocarbon fluids.

The hydrocarbon fluid also preferably has a vapour pressure at 20° C. lower than or equal to 0.01 kPa. In one embodiment, the hydrocarbon fluid also preferably has a flash point higher than or equal to 110° C. according to standard EN ISO 2719 and a vapour pressure at 20° C. lower than or equal to 0.01 kPa. Preferably. the hydrocarbon fluid has a flash point higher than or equal to 120° C. and a vapour pressure at 20° C. lower than or equal to 0.01 kPa. And more preferably, it has a flash point higher than or equal to 140° C. and a vapour pressure at 20° C. lower than or equal to 0.01 kPa. The hydrocarbon fluid additionally has kinematic viscosity at 40° C. lower than or equal to 5 cSt, preferably lower than or equal to 4 cSt, and more preferably lower than or equal to 3.5 cSt according to standard EN ISO 3104.

The hydrocarbon fluid used in the invention has a bio-based carbon content higher than or equal to 90% by weight relative to the total weight of the hydrocarbon oil, and it is ideally obtained from the processing of raw materials from biomass. The carbon of a biomaterial results from the photosynthesis of plants and hence from atmospheric CO2. The degradation (by degradation, it is also meant the combustion/end-of-life incineration) of these CO2 materials does not therefore contribute to global warming since there is no increase in carbon released into the atmosphere. Evaluation of the CO2 of biomaterials is therefore distinctly easier and contributes towards reducing the carbon footprint of the products obtained (solely the energy required for manufacture is to be taken into account). On the contrary, a material of fossil origin and CO2-degraded will contribute towards increasing the CO2 level and hence to global warming. The hydrocarbon fluid used in the invention will therefore have a better carbon footprint than compounds obtained from a fossil source.

The term “biocarbon” indicates that the carbon is of natural origin and is derived from a biomaterial as indicated below. The biocarbon content and biomaterial content are expressions indicating the same value. A material of sustainable origin or a biomaterial is an organic material in which the carbon is derived from recently fixed CO2 (on a human scale) by photosynthesis using the atmosphere. A biomaterial (Carbon of 100% natural origin) has a ¹⁴C/¹²C isotope ratio greater than 10⁻¹², typically about 1.2×10⁻¹², whilst a fossil material has a zero ratio. The ¹⁴C isotope is formed in the atmosphere and then integrated via photosynthesis over a time scale of a few tens of years at most. The half-life of ¹⁴C is 5730 years. Therefore the materials derived from photosynthesis, namely plants in general, necessarily have a maximum content of ¹⁴C isotope.

Determination of the content of biomaterial or biocarbon is given in accordance with standards ASTM D 6866-12, method B (ASTM D 6866-06) and ASTM D 7026 (ASTM D 7026-04). Standard ASTM D 6866 concerns the “determination of the biobased content of solid, liquid and gaseous samples using radiocarbon analysis”, whilst standard ASTM D 7026 concerns “the sampling and reporting of results for determination of biobased content of materials via carbon isotope analysis”. The latter standard mentions the former in the first paragraph thereof.

The first standard describes a test for measuring the ¹⁴C/¹²C ratio of a sample and comparison thereof with the ¹⁴C/¹²C ratio of a reference sample of 100% sustainable origin, to give a relative percentage of C of sustainable origin in the sample. The standard is based on the same notions as 14C dating but without applying dating equations. The ratio thus calculated is given as “pMC” (percentage Modern Carbon). If the material to be analysed is a mixture of biomaterials and fossil materials (without radioactive isotope), the pMC value obtained is directly correlated with the amount of biomaterial contained in the sample. The reference value used for ¹⁴C dating is a value dating from the 1950s. This year was chosen on account of nuclear testing in the atmosphere which released large quantities of isotopes into the atmosphere after this date. The 1950 reference corresponds to a pMC value of 100. Having regard to thermonuclear tests, the current value to be retained is about 107.5 (which corresponds to a correction factor of 0.93). The radioactive carbon signature of a plant at the current time is therefore 107.5. A signature of 54 pMC and 99 pMC therefore corresponds to a quantity of biomaterial in the sample of 50% and 93% respectively.

The hydrocarbon fluid conforming to the invention has a biomaterial content of at least 90%. This content is advantageously higher, in particular higher than or equal to 95%, preferably higher than or equal to 98%, and advantageously it is 100%. In one embodiment, the ¹⁴C/¹²C isotope ratio of the hydrocarbon fluid used in the invention is between 1.15 and 1.2×10⁻¹².

In addition to a particularly high biomaterial content, the hydrocarbon fluid used in the invention can have particularly good biodegradability. The biodegradation of an organic chemical product refers to the reducing of the complexity of chemical compounds via the metabolic activity of microorganisms. Under aerobic conditions, microorganisms convert organic substances to carbon dioxide, water, and biomass. The OCDE 306 method is used to evaluate the biodegradability of individual substances in seawater. According to this method, the hydrocarbon fluid in one embodiment has 28-day biodegradability of at least 60%, preferably at least 70%, more preferably at least 75% and advantageously at least 80%.

The OCDE 306 method is the following:

The closed bottle method entails dissolving a predetermined quantity of the substance to be tested in a test medium a usual concentration of 2-10 mg/L, one or more concentrations optionally being used. The solution is kept in a filled closed bottle away from light at a constant temperature in the range of 15-20° C. Degradation is monitored via analysis of oxygen over a 28-day period. 24 bottles are used (8 for the substance to be tested, 8 for the reference compound and 8 for the nutrients). All the analyses are performed on several bottles. At least 4 determinations of dissolved oxygen are carried out (day 9, 5, 15 and 20) applying a chemical or electrochemical method.

The hydrocarbon fluid used in the invention can be obtained with the method described in application WO2016/185047. In particular, a composition used in the invention comprises from 15% to 99% by weight, preferably from 20% to 95%, more preferably from 25% to 90%, advantageously from 30% to 90% by weight of at least one hydrocarbon fluid having a boiling point of at least 30° C., relative to the total weight of the composition.

### Base Oil(s)

The composition used in the invention may comprise one or more base oils. These base oils can be chosen from among base oils conventionally used in the sphere of lubricating oils, such as mineral, synthetic or natural, animal or vegetable oils, or mixtures thereof. It can be a mixture of several base oils e.g. a mixture of two, three or four base oils. The base oils of the lubricant compositions under consideration in the invention can particularly be oils of mineral or synthetic origin belonging to groups I to V of the classes defined in the API classification (or equivalents thereof in the ATIEL classification) and given in Table 1 below, or mixtures thereof.

TABLE 1

| | Saturates | Sulfur | Viscosity |
|---|---|---|---|
| | content | content | Index (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydrocracked or | | | |
| hydro-isomerized oils | | | |

| | |
|---|---|
| Group IV | Polyalphaolefins (PAOs) |
| Group V | Esters and other bases not |
| | included in Groups I to IV |

Mineral base oils include all types of base oils obtained by atmospheric and vacuum distillation of crude oil, followed by refining operations such as solvent extraction, deasphalting, solvent dewaxing, hydrotreatment, hydrocracking, hydroisomerization and hydrofinishing. Mixtures of synthetic and mineral oils, possibly being biosourced, can also be employed. There is generally no limit as to the different base oils used to produce the compositions of the invention, other than that they must have properties, in particular in terms of viscosity, viscosity index, or oxidation resistance, adapted for use in propulsion systems of electric or hybrid vehicles.

The base oils of the compositions used in the invention can also be chosen from among synthetic oils such as certain esters of carboxylic acids and alcohols, polyalphaolefins (PAOs), and polyalkylene glycols (PAGs) obtained by polymerization or copolymerization of alkylene oxides having 2 to 8 carbon atoms, in particular 2 to 4 carbon atoms. The PAOs used as base oils are obtained for example from monomers having 4 to 32 carbon atoms, e.g. from octene or decene. The weight average molecular weight of the PAO can vary fairly widely. Preferably, the weight average molecular weight of the PAO is less than 600 Da. The weight average molecular weight of the PAO can also range from 100 to 600 Da, from 150 to 600 Da, or from 200 to 600 Da.

Advantageously, the base oil(s) of the lubricating composition of the invention can be chosen from among the base oils in Group II or III. In one alternative embodiment, the base oil(s) of the composition used in the invention are chosen from among polyalphaolefins (PAOs), polyalkylene glycols (PAGs) and the esters of carboxylic acids and alcohols.

In particular, a composition used in the invention comprises from 15% to 99% by weight, preferably from 20% to 95%, more preferably from 25% to 90%, advantageously from 30% to 90% by weight of base oil(s) relative to the total weight of the composition.

The composition used in the invention comprises perfluorooctyl bromide (PFOB).

In particular, a composition used in the invention comprises from 1% to 85% by weight, preferably from 5% to 80%, more preferably from 10% to 75%, advantageously from 10% to 70% by weight of PFOB, relative to the total weight of the composition. In one embodiment, the composition used in the invention has a weight ratio of [PFOB] to [hydrocarbon fluid(s) and/or base oil(s)] of less than 1, preferably less than or equal to 0.75, more preferably less than or equal to 0.50.

In one embodiment, the composition used in the invention, relative to the total weight of the composition, comprises:
from 15 to 99% by weight, preferably from 20 to 95% by weight, more preferably from 25 to 90% by weight of hydrocarbon fluid(s) having an initial boiling point of at least 30° C., and/or of base oil(s);
from 1 to 85% by weight, preferably from 5 to 80% by weight, more preferably from 10 to 75% by weight of perfluorooctyl bromide.

In one embodiment, the composition used in the invention further comprises at least one flame retardant replying to formula (I):

RF-L-RH (I)
where:
RF is a hydrocarbon group in particular having 1 to 22, preferably 1 to 20 and more preferably 1 to 16 carbon atoms;
RH is a hydrocarbon group in particular having 1 to 22, preferably 1 to 20 and more preferably 1 to 16 carbon atoms; and
L is a linker chosen from the following groups: —CH₂, —CH═CH—, —O—, —S— or —PO₄—;
RF and/or RH possibly also comprising at least one element chosen from among the elements in the halogen class, such as preferably fluorine, bromine and/or chlorine,
said flame retardant differing from perfluorooctyl bromide.

This flame retardant of formula (I) allows improved stability of the composition, in particular through the formation of a stable nano-emulsion. In one embodiment, the group RF is perfluorinated or partially fluorinated. In the present invention the term “partially fluorinated group” means that at least 60% of the hydrogen atoms in the group concerned are replaced by fluorine atoms, e.g. between 60 and 80%.

In one particular embodiment, the group RF has between 1 and 22, preferably between 1 and 20, more particularly between 1 and 16 carbon atoms. Said group can optionally be interrupted by 1 to 4 heteroatoms chosen from among a nitrogen atom and oxygen atom. This group can also be linear or branched.

Advantageously, it is a perfluorinated or partially fluorinated (C₁-C₁₆) alkyl group, optionally interrupted by one or two heteroatoms chosen from among a nitrogen atom and oxygen atom. Said group RF can be chosen for example from among the following groups:
CF₃(CF₂)ₘ—,
C(CF₃)₃(CF₂)ₘ—,
(CF₃)₂CF(CF₂)ₘ—,
(CF₃)₂CF—, et
(CF₃)CF₂—,
(CF₃)(CF₂)₃—, with m being an integer of between 1 and 15.
   These examples are not limiting.

In one particular embodiment, the group RH comprises between 1 and 22 carbon atoms, preferably between 1 and 20, more preferably between 1 and 16 carbon atoms. In one particular embodiment, this group RH may comprise between 1 and 4 heteroatoms chosen from among a nitrogen atom and oxygen atom. Also, this group can be linear or branched. It can be saturated or may comprise 1 to 4 unsaturations.

Advantageously, it is a (C₁-C₁₅)alkyl group or (C₂-C₁₅)alkenyl group, said group optionally being substituted by a hydrocarbon ring such as the (C₃-C₆)cycloalkyl, phenyl or benzyl group. Said group RH can particularly be chosen from among the following groups, without being limited thereto:
—(CH₂)ₙCH₃,
—(CH₂)ₚC₆H₄,
—(CH₂)_{q}O(CH₂)ᵣCH₃, et.
—(CH₂)ₛC═C(CH₂)ₜCH₃
with n being an integer of between 1 and 21, in particular between 7 and 21;
p being between 1 and 16, in particular between 2 and 10;
q and r each independently being between 1 and 16, with q+r being lower than or equal to 21 and advantageously higher than 7;
s and t each independently being between 1 and 16, with s+t being lower than or equal to 19, and advantageously higher than 5.

In one particular embodiment, the flame retardant can be chosen from among the compounds of formula (I) where RF is a perfluorinated or partially fluorinated (C₂-C₁₂)alkyl group, RH is a (C₁-C₁₂)alkyl group, in particular (C₆-C₁₂) alkyl or (C₂-C₁₂)alkenyl, in particular (C₆-C₁₂)alkenyl, said group optionally being substituted by a hydrocarbon ring such as the (C₃-C₆)cycloalkyl, phenyl or benzyl group, and said group possibly being interrupted by 1 or 2 heteroatoms chosen from among nitrogen or oxygen, and L is a linker chosen from among —CH₂—, —CH═CH— and —O—.

It is understood in the present invention that the flame retardant of formula (I) such as previously defined can be in the form of a mixture of flame retardants of formula (I) such as previously defined.

In the present invention, the following terms are defined as follows:
“(Cᵢ-Cⱼ) alkyl”, refers to a linear or branched, saturated hydrocarbon chain having i to j carbon atoms e.g. a (C₁-C₁₂)alkyl group. As nonlimiting examples, mention can be made of the following groups: methyl, ethyl, 1-propyl, 2-propyl, butyl, pentyl, hexyl, heptyl, and decyl;
“(C₂-Cₓ) alkenyl”, refers to a linear or branched, hydrocarbon chain having unsaturations and having 2 to x carbon atoms, e.g. a (C₂-C₁₂)alkyl group. As nonlimiting examples, mention can be made of the following groups: ethylene, propylene, butylene, pentylene, hexylene and decylene
“(C₃-C₆)cycloalkyl” refers to a cyclic, saturated hydrocarbon chain. As nonlimiting examples the following groups can be cited: cyclopropyl, cyclobutyl, cyclopentyl and cyclohexyl.

In the present invention, the flame retardant(s) of formula (I) can be contained in a content of between 5 and 35% by weight relative to the total weight of the composition used in the present invention, in particular in a content of between 7% and 30% by weight, more particularly in a content of between 10% and 20% by weight.

Therefore, in one embodiment, the composition used in the invention comprises:
from 15 to 90% by weight, preferably from 40 to 90% by weight of hydrocarbon fluid(s) having an initial boiling point of at least 30° C., and/or of base oil(s);
from 5 to 75% by weight, preferably 7 to 50% by weight of perfluorooctyl bromide;
from 5 to 35% by weight, preferably 7 to 50% by weight of flame retardant(s) meeting formula (I),
relative to the total weight of the composition.

### Additional Additives

Additional additives can be used in the cooling composition of the invention. Among these additives, mention can be made of antioxidants, anti-corrosion additives, antifoam additives and pour point depressants. In one particularly preferred embodiment, the cooling composition of the invention comprises at least one antioxidant additive. Antioxidant additives generally allow delayed degradation of the composition when in service. This degradation can translate in particular as the formation of deposits, the presence of sludge or an increase in the viscosity of the composition.

Antioxidant additives particularly act as radical inhibitors or hydroperoxide decomposers. Among antioxidant additives frequently employed, mention can be made of antioxidant additives of phenolic type, antioxidant additives of amine type, sulfur-phosphorous antioxidant additives. Some of these antioxidant additives e.g. sulfur-phosphorous antioxidant additives may generate ash. Phenolic antioxidant additives can be ashless or can be in the form of neutral or basic metal salts. The antioxidant additives can be chosen in particular from among sterically hindered phenols, sterically hindered phenol esters, and sterically hindered phenols comprising a thioether bridge, diphenylamines, diphenylamines substituted by at least one C₁-C₁₂ alkyl group, N,N′-dialkyl-aryl-diamines, and mixtures thereof.

Preferably in the invention, the sterically hindered phenols are chosen from among compounds comprising a phenol group in which at least one vicinal carbon of the carbon carrying the alcohol function is substituted by at least one C₁-C₁₀ alky group, preferably a C₁-C₆ alkyl group, more preferably a C₄ alkyl group, preferably by the tert-butyl group.

Amine compounds are another class of antioxidant additives that can be used, optionally in combination with phenolic antioxidant additives. Examples of amine compounds are the aromatic amines e.g. the aromatic amines of formula NR⁴R⁵R⁶ where R⁴ is an optionally substituted aliphatic group or aromatic group, R⁵ is an optionally substituted aromatic group, R⁶ is a hydrogen atom, an alkyl group, aryl group or group of formula R⁷S(O)_{z}R⁸ where R⁷ is an alkylene group or alkenylene group, R⁸ is an alkyl group, alkenyl group or aryl group and z is 0, 1 or 2.

Sulfurized alkyl phenols or the alkali or alkaline-earth metal salts thereof can also be used as antioxidant additives. Another class of antioxidant additives is that of copper compounds e.g. copper thio- or dithio-phosphates, copper and carboxylic acid salts, copper dithiocarbamates, sulfonates, phenates and acetylacetonates. Copper I and II salts, the salts of succinic acid or anhydride can also be used.

The cooling composition of the invention or used according to the invention may contain any type of antioxidant additives known to skilled persons. The cooling composition of the invention or used according to the invention may comprise from 0.1 to 2% by weight of at least one antioxidant additive, relative to the total weight of the composition. In one particular embodiment, the cooling composition of the invention or used according to the invention is free of antioxidant additive of aromatic amine type or of sterically hindered phenol type.

The cooling composition of the invention or used according to the invention may comprise at least one anticorrosion additive. The anti-corrosion additive advantageously allows the delaying or preventing of corrosion of the metal parts of the battery. A cooling composition of the invention or used according to the invention may comprise from 0.01 to 2 weight %, or from 0.01 to 5 weight %, preferably from 0.1 to 1.5 weight %, or from 0.1 to 2 weight % of anticorrosion agent, relative to the total weight of the composition.

The cooling composition of the invention or used according to the invention may additionally comprise at least one antifoam agent. The antifoam agent can be chosen from among polyacrylates or waxes.

The cooling composition of the invention may comprise from 0.01 to 2 weight %, or from 0.01 to 5 weight %, preferably from 0.1 to 1.5 weight %, or 0.1 to 2 weight % of antifoam agent relative to the total weight of the composition. The cooling composition of the invention or used according to the invention may also comprise at least one pour point depressant PPD. By slowing the formation of paraffin crystals, pour point depressants generally improve the cold start behaviour of the composition. As examples of pour point depressants mention can be made of alkyl polymethacrylates, polyacrylates, polyarylamides, polyalkylphenols, polyalkylnaphthalenes, alkylated polystyrenes.

The cooling composition of the invention or used according to the invention may additionally comprise at least one radical inhibitor. Said radical inhibitors are known per se by skilled persons and can be of different chemical type, and in particular may belong to different chemical families.

In terms of formulation of the composition of the present invention or used according to the invention, all methods known to skilled persons can be used for these additions to the fluid or to the oil. Among radical inhibitors, phosphorus-based radical inhibitors can particularly be cited. Among phosphorus-based radical inhibitors, a distinction is made between compounds in which the phosphorus is P(V) or pentavalent phosphorus, and compounds in which the phosphorus is P(III) or trivalent phosphorus.

Among these compounds in the form of pentavalent phosphorus, P(V), particular mention can be made of the phosphate family and in particular triethylphosphate, trimethylphosphate, optionally fluorinated alkylphosphates, or arylphosphates. As fluorinated alkylphosphate, particular mention is made of tris (2,2,2-trifluoroethyl) phosphate. As arylphosphates, particular mention is made of triphenylphosphate, tricresylphosphate or trixylenylphosphate.

Still among these compounds in P(V) form, the family of phosphazenes can particularly be cited. In this family, characterised by the fact that the representatives thereof comprise at least one double bond between a pentavalent phosphorus atom and a nitrogen atom, the cyclic compounds are preferred. Particular mention is made of hexamethoxycyclotriphosphazene. Among these compounds in the form of a trivalent phosphorus, P(III), the family of phosphites can particularly be cited. In this family, particular mention is made of tris(2,2,2-trifluoroethyl)phosphite.

When the cooling composition is used in a lubricating system, the cooling composition of the invention or used according to the invention may also comprise any type of additives adapted for use in a lubricant for propulsion system of an electric or hybrid vehicle, and can be called a lubricating composition. Said additives, known to persons skilled in the field of lubrication for propulsion systems of electric or hybrid vehicles, can be chosen from among friction modifiers, detergents, antiwear additives, extreme pressure additives, dispersants and mixtures thereof.

The composition of the invention or used according to the invention can be prepared by simply mixing the ingredients. The composition defined in the invention is used for cooling in a mobile or stationary system and/or to prevent or delay the spread of thermal runaway in a mobile or stationary system. Preferably, the composition is in direct contact with at least unit of the mobile or stationary system.

Preferably, the composition is used as battery cooling composition (for mobile or stationary applications), as data centre cooling composition, as hydraulic fluid, as cooling fluid for antenna of 5G type, as heat exchange fluid in a heating system, for charging stations including for electric vehicles, for energy storage systems, or for photovoltaic panels, as working fluid for heat pumps. In one embodiment, the mobile system is a propulsion system of an electric or hybrid vehicle, preferably a battery and/or the power electronics of an electric or hybrid vehicle. The composition defined in the present invention can be placed in direct contact with the propulsion system to cool the engine, power electronics and battery via this direct contact of said composition with these units, whilst ensuring increased safety in the event of runaway of said battery. The composition thus in direct contact with these units provides better cooling than conventional cooling by air and by indirect contact with water. This direct contacting additionally allows better dissipation of heat.

Cooling by air in the prior art allows direct cooling, but air is a very poor heat-dissipating fluid. On the contrary, water is a fluid that performs well for cooling but is not compatible for direct contact with the motor, power electronics and battery.

Advantageously, the composition used in the invention is placed in contact with the battery via immersion or semi-immersion to fulfil the twofold function thereof for batteries: cooling and fire protection. By “immersion” it is meant that the entirety of the battery is surrounded by the cooling composition of the present invention. By “semi-immersion” it is meant that only a portion of the battery is in contact with said composition.

Alternatively, the cooling composition of the invention is advantageously placed in direct contact with the batteries using the methods described below. As batteries suitable for propulsion systems of an electric or hybrid vehicle, Li-ion batteries are cited or Nickel-Cadmium batteries. An electric motor is typically powered by an electric battery. Lithium-ion batteries are the most widespread in electric vehicles. The development of ever more powerful batteries and of increasingly small size has brought the onset of cooling problems of such batteries. As soon as a battery exceeds temperatures in the region of 50 to 60° C., there is a high risk of the battery catching fire and even of explosion. There is also a need to maintain the battery at a temperature higher than about 20 to 25° C. to prevent the battery from discharging too quickly and to extend the lifetime thereof. The battery can be in immersion or semi-immersion, static or in circulation, in the composition defined in the invention.

As examples of direct contacting, mention can be made of cooling via injection, jetting, spraying, or the forming of a mist from the composition of the invention under pressure and contacting the battery under gravity. Advantageously, the composition is injected via a jet under fairly high pressure into the zones to be cooled of the propulsion system. Advantageously, the shear resulting from this injection allows the viscosity of the fluid to be reduced at the injection zone, compared with kinematic viscosity at rest, and thereby further increase the cooling potential of the composition.

In one embodiment, the composition defined in the invention is used both to cool and to prevent or delay the spread of fire at the power electronics and battery in a propulsion system of an electric or hybrid vehicle, and to lubricate the transmissions in a propulsion system of an electric or hybrid vehicle. In one embodiment, the composition defined in the invention is used both for cooling, for preventing or delaying the spread of fire, and also to lubricate the motor in a propulsion system of an electric or hybrid vehicle. In one embodiment, the stationary system is chosen from among data centres, heating systems, heat pumps, hydraulic systems, antennas of 5G type, charging stations including for electric vehicles, energy storage systems, or photovoltaic panels.

Achieving data energy efficiency is currently widely sought. Many aspects of our daily lives (smart devices, homes, cities, and self-drive vehicles) are dependent on centres called “datacentres”. These centres are costly in terms of energy consumption. Conventionally, these datacentres are cooled by air-conditioning but the invention proposes cooling these datacentres with the composition of the invention, preferably by immersion of the units of datacentres in the composition defined in the invention.

The invention also concerns a method for cooling and/or for fire-proofing a mobile or stationary system, comprising at least one step of contacting at least one unit of the mobile or stationary system with the composition defined in the present invention. In particular, the method comprises at least one heat exchange step between the composition and the unit of the mobile or stationary system.

The invention further concerns a method for cooling and for fire-proofing a battery of a propulsion system of an electric or hybrid vehicle, comprising at least one step of contacting at least one battery, in particular a Lithium-ion battery or Nickel-Cadmium battery, with a composition such as defined above. In one particular embodiment, the contacting step involves immersion or semi-immersion of the battery in said composition, or the injection of said composition onto the surface of the battery.

A further subject of the invention is a composition as such which, relative to the total weight of the composition, comprises:
from 15 to 90% by weight of hydrocarbon fluid(s) having an initial boiling point of at least 30° C., and/or of base oil(s);
from 5 to 75% by weight of perfluorooctyl bromide;
from 5 to 35% by weight of flame retardant(s) meeting formula (I):

RF-L-RH (I)
where:
RF is a hydrocarbon group, in particular comprising from 1 to 22, preferably 1 to 20, more preferably 1 to 16 carbon atoms;
RH is a hydrocarbon group, in particular comprising from 1 to 22, preferably 1 to 20, more preferably 1 to 16 carbon atoms;
L is a linker chosen from the following groups: —CH₂, —CH═CH—, —O—, —S— or —PO₄—,
RF and/or RH possibly also comprising an element chosen from elements in the halogen class such as preferably fluorine, bromine and/or chlorine;
a composition in which the weight ratio of perfluorooctyl bromide to hydrocarbon fluid(s) and/or base oil(s) is less than 1.

The hydrocarbon fluid(s) used in the composition of the invention can have one or more of the characteristics defined herein for the use of the invention. The base oil(s) used in the composition of the invention can have one or more of the characteristics defined herein for the use of the invention. The flame retardant(s) of formula (I) used in the composition of the invention can have one or more the characteristics defined herein for the use of the invention.

The composition of the invention may additionally comprise one or more additives such as defined herein with respect to the use of the invention. In one embodiment of the composition of the invention, the weight ratio of perfluorooctyl bromide to hydrocarbon fluid(s) and/or base oil(s) is less than 0.75, preferably less than 0.5.

In one embodiment, the composition of the invention comprises:
from 15 to 90% by weight, preferably 40 to 90% by weight of hydrocarbon fluid(s) having an initial boiling point of at least 30° C., and/or of base oil(s);
from 5 to 75% by weight, preferably 7 to 50% by weight of perfluorooctyl bromide;
from 5 to 35% by weight, preferably 7 to 50% by weight of flame retardant(s) meeting formula (I),
relative to the total weight of the composition.

The composition of the invention can be employed according to the use(s) and method(s) defined in the invention.

### EXAMPLES

### Example 1: Preparation of the Tested Compositions

F6H10 represents 1,1,1,2,2,3,3,4,4,5,5,6,6-Tridecafluorohexadecane.
PAO 2 designates a polyalphaolefin having kinematic viscosity at 100° C. of about 2.
Tested compositions are described in Tables 2 and 3; the proportions are given in weight percent in Tables 2 and 3.

TABLE 2

| | CC1 | CC2 | CC3 | CC4 | CC5 | I1 | I2 | I3 |
|---|---|---|---|---|---|---|---|---|
| Dodecane | 100% | 0% | 84% | 64% | 80% | 68% | 41% | 50% |
| F6H10 | | 100% | 16% | 36% | 20% | 13% | 24% | 12% |
| PFOB | | 0% | 0% | 0% | 0% | 19% | 35% | 37% |

TABLE 3

| | CC6 | CC7 | I4 |
|---|---|---|---|
| PAO 2 | 100% | 77.8% | 70% |
| F6H10 | | 22.2% | 20% |
| PFOB | | | 10% |

### Example 2: Measurement of Interfacial Tension

The interfacial tension of different compositions was measured using a TECLIS tensiometer with the following method:

Axisymmetric analysis of bubble shape was applied to a rising air bubble (2-3 μL) formed at the tip of a steel capillary (tip diameter 1 mm) in the hydrocarbon, in pure F6H10 solution, in F6H10 solution in the hydrocarbon, or in a ternary microemulsion placed in the measuring cell (10 mL). Time dependency of surface tension during adsorption at the air/water interface was measured with a Tracker® tensiometer (Teclis Scientific, Lyon, France). The volume of the bubbles was held constant during measurements, with the exception of experiments conducted in oscillating mode (ΔA=15%, t=10s).

Measurements of oscillating bubbles: Oscillations were produced by a position-encoded motor and transmitted by a piston coupled to the syringe carrying the capillary. Oscillating rate was applied when the determined bubble volume was reached. The values given are mean values obtained by processing data with a low-pass digital filter (3^{rd} order Butterworth filter). The viscoelastic moduli were calculated as E=dg/dlnA.

The surface tension is given in Table 4.

TABLE 4

| | CC1 | CC2 | CC3 | CC4 | I1 | I2 |
|---|---|---|---|---|---|---|
| Surface tension | 26 | 20 | 24 | 23 | 19 | 19 |
| (mN/m) | | | | | | |

The compositions of the invention I1 and I2 show a lower surface tension than compositions CC1, CC2, CC3 and CC4 comprising either the fluid alone or the mixture of fluid and a flame retardant. A low surface tension allows improved capability of cooling and limiting the spread of fire since the composition will be able to line the surfaces of interest in the event of a temperature rise.

### Example 3: Measurement of the Viscoelastic Modulus

The viscoelastic modulus of different compositions was measured following the method described in Example 2.

The viscoelastic modulus is given in Table 5.

TABLE 5

| | CC1 | CC5 | CC6 | CC7 | I3 | I4 |
|---|---|---|---|---|---|---|
| Viscoelastic | 2.2 | 2.1 | 1.1 | 1.6 | 0.3 | 0.3 |
| modulus (mN/m) | | | | | | |

The compositions of the invention I3 and I4 show a distinctly lower viscoelastic modulus than compositions CC1, CC5, CC6 and CC7 comprising the fluid/base oil either alone or in the mixture of fluid/base oil and a flame retardant. A low viscoelastic modulus allows improved capability of cooling and limiting the spread of fire since the composition will be able to line the surfaces of interest in the event of a temperature rise.

The invention claimed is:

1. A method for cooling a mobile or stationary system and/or for preventing or delaying the spread of thermal runaway in a mobile or stationary system, the method comprising at least one step of contacting at least one unit of the mobile or stationary system with a composition comprising:
at least one hydrocarbon fluid having an initial boiling point of at least 30° C., or at least one base oil; and
perfluorooctyl bromide.

2. The method according to claim 1, wherein the composition comprises:
from 15 to 99% by weight of hydrocarbon fluid(s) having an initial boiling point of at least 30° C., and/or of base oil(s); and
from 1 to 85% by weight of perfluorooctyl bromide;
relative to the total weight of the composition.

3. The method according to claim 1, wherein the composition further comprises at least one flame retardant replying to formula (I):
RF-L-RH (I)
wherein:
RF is a hydrocarbon group;
RH is a hydrocarbon group; and
L is a linker chosen from the following groups: —CH₂—, —CH═CH—, —O—, —S— or —PO₄—;
RF and/or RH possibly also comprising at least one element chosen from elements in the halogen class.

4. The method according to claim 3, wherein RF is perfluorinated or partially fluorinated.

5. The method according to claim 3, wherein the composition comprises:
from 15 to 94% by weight of hydrocarbon fluid(s) having an initial boiling point of at least 30° C., and/or of base oil(s);
from 1 to 75% by weight of perfluorooctyl bromide; and
from 5 to 35% by weight of flame retardant(s) replying to formula (I),
relative to the total weight of the composition.

6. The method according to claim 1, wherein the composition is in direct contact with at least one unit of the mobile or stationary system.

7. The method according to claim 1, wherein the composition is used as battery cooling composition, as data centre cooling composition, as hydraulic fluid, as cooling fluid for antenna of 5G type, as heat exchange fluid in a heating system, as heat exchange fluid for charging stations including for electric vehicles, as heat exchange fluid for energy storage systems, or also as heat exchange fluid for photovoltaic panels, as working fluid for heat pumps.

8. The method according to claim 1, wherein the mobile system is a propulsion system of an electric or hybrid vehicle.

9. The method according to claim 1, wherein the stationary system is chosen from among datacentres, heating systems, heat pumps, relay antennas of 5G type, hydraulic systems, charging stations including for electric vehicles, energy storage systems, or photovoltaic panels.

10. A composition comprising, relative to the total weight of the composition:
from 15 to 94% by weight of hydrocarbon fluid(s) having an initial boiling point of at least 30° C., and/or of base oil(s);
from 1 to 75% by weight of perfluorooctyl bromide;
from 5 to 35% by weight of flame retardant(s) replying to formula (I):
RF-L-RH (I)
wherein:
RF is a hydrocarbon group;
RH is a hydrocarbon group;
L is a linker chosen from the following groups: —CH₂—, —CH═CH—, —O—, —S— or —PO₄—;
RF and/or RH possibly also comprising an element chosen from among elements in the halogen class; and
a composition wherein the weight ratio of perfluorooctyl bromide to hydrocarbon fluid(s) and/or base oil(s) is less than 1.

11. The composition according to claim 10, wherein the weight ratio of perfluorooctyl bromide to hydrocarbon fluid(s) and/or base oil(s) is less than 0.75.

12. The composition according to claim 10, wherein RF is perfluorinated or partially fluorinated.

13. The method according to claim 1, further comprising at least one heat exchange step between the composition and the unit of the mobile or stationary system.

14. The method according to claim 1, wherein the composition further comprises at least one flame retardant replying to formula (I):
RF-L-RH (I)
wherein:
RF is a hydrocarbon group having 1 to 22 carbon atoms;
RH is a hydrocarbon group having 1 to 22 carbon atoms;
L is a linker chosen from the following groups: —CH₂—, —CH═CH—, —O—, S— or PO4-; and
RF and/or RH possibly also comprising at least one element chosen from fluorine, bromine, and/or chlorine.

15. The method according to claim 3, wherein RF is a perfluorinated or partially fluorinated (C1-C16)alkyl group optionally interrupted by one or two heteroatoms chosen from among a nitrogen atom and oxygen atom.

16. The method according to claim 1, wherein the mobile system a battery and/or the power electronics of an electric or hybrid vehicle.

17. The composition according to claim 10, wherein the weight ratio of perfluorooctyl bromide to hydrocarbon fluid(s) and/or base oil(s) is less than 0.5.

18. The composition according to claim 10, wherein RF is a perfluorinated or partially fluorinated (C1-C16)alkyl group optionally interrupted by one or two heteroatoms chosen from among a nitrogen atom and oxygen atom.

19. A method for cooling and for fire-proofing a battery of a propulsion system of an electric or hybrid vehicle, comprising at least one step of contacting at least one battery with a composition comprising:
at least one hydrocarbon fluid having an initial boiling point of at least 30° C., or at least one base oil; and
perfluorooctyl bromide.
